(19) United States
(12) Patent Application Publication
(10) Pub. No.: US 2025/0266019 A1
(43) Pub. Date: Aug. 21, 2025

(54) PERCUSSION INSTRUMENT AND MOUNTING METHOD FOR MOUNTING MEMBER

(71) Applicant: Roland Corporation, Shizuoka (JP)

(72) Inventor: Syota Kobayashi, Hamamatsu (JP)

(73) Assignee: Roland Corporation, Shizuoka (JP)

(21) Appl. No.: 19/050,028

(22) Filed: Feb. 10, 2025

(30) Foreign Application Priority Data
Feb. 21, 2024 (JP) 2024-024556

(51) Int. Cl. G10D 13/11; G10D 13/10

(52) U.S. Cl. CPC G10D 13/11; G10D 13/26

(57) ABSTRACT

A percussion instrument includes a housing, and a lifter provided on an outer circumference side of the housing. The lifter includes a fixed member fixed to a housing side, a mounting member configured to have a variable mounting position in a front-rear direction relative to the fixed member, and a bolt fixing the mounting member to the fixed member. The mounting member includes a mounting portion to which a foot pedal is attached, and fastening portions provided on both sides of the mounting portion in a left-right direction and fastened to the fixed member by a pair of the bolts on left and right sides. A pair of the bolts fasten the fastening portions at positions where respective axial centers do not align.

### CROSS-REFERENCE TO RELATED APPLICATION

This application claims the priority benefits of Japanese application no. 2024-024556, filed on Feb. 21, 2024. The entirety of the above-mentioned patent application is hereby incorporated by reference herein and made a part of this specification.

### BACKGROUND

### Technical Field

The disclosure relates to a percussion instrument and a mounting method for a mounting member, and particularly relates to a percussion instrument and a mounting method for a mounting member that allow easy adjustment of the relative position between a foot pedal and the percussion instrument.

### Description of Related Art

For a percussion instrument whose striking surface is to be hit by a beater of a foot pedal, there is known a technique of adjusting the impact position of the beater on the striking surface by raising the height of the striking surface using a lifter provided on the outer circumference side of a housing. For example, Patent Literature 1 (Japanese Patent Application Laid-Open No. 2014-071196 (for example, paragraphs 0032 to 0040, and FIG. 1 to FIG. 3)) describes a bass drum lifter 20 that includes a pedal connection member 22 (mounting member) to which a pedal device P (foot pedal) is attached, and a drum connection member 23 (fixed member) which is fixed to a bass drum 10 (percussion instrument).

A long hole 30a that extends in the front-rear direction is formed in a retainer 30 of the drum connection member 23, and an insertion hole 36a is formed in a base 33 at a position corresponding to the long hole 30a. A bolt 40 inserted through these long hole 30a and insertion hole 36a from below is fastened to a nut plate 35 stacked on top of the base 33.

In a state where the bolt 40 is loosened, the mounting position of the retainer 30 (pedal connection member 22) relative to the base 33 can be adjusted in the front-rear direction by sliding the long hole 30a relative to the bolt 40. In other words, since the relative position between the bass drum 10 and the pedal device P in the front-rear direction can be adjusted, it is possible to prevent the pedal device P from interfering with a striking surface head 15, or to finely adjust the impact position of the beater.

However, according to the related technology described above, the bolt 40 is fastened from the lower surface side of the retainer 30. Therefore, in order to fasten the bolt 40, it is necessary to insert a hand between the installation surface on which the bass drum 10 is installed and the bass drum lifter 20, or to turn the bass drum 10 upside down. Thus, it has been troublesome for an operation of adjusting the relative position between the pedal device P (foot pedal) and the bass drum 10 (percussion instrument).

The disclosure provides a percussion instrument and a mounting method for a mounting member that allow easy adjustment of the relative position between the foot pedal and the percussion instrument.

### SUMMARY

A percussion instrument according to the disclosure includes a housing, and a lifter provided on an outer circumference side of the housing. The lifter includes a fixed member fixed to the housing side, a mounting member configured to have a variable mounting position in a front-rear direction relative to the fixed member, and a bolt fixing the mounting member to the fixed member. The mounting member includes a mounting portion to which a foot pedal is attached, and fastening portions provided on both sides of the mounting portion in a left-right direction and fastened to the fixed member by a pair of the bolts on the left and right sides. A pair of the bolts fasten the fastening portions at positions where respective axial centers do not align.

A mounting method for a mounting member according to the disclosure is provided for a percussion instrument that includes a housing, and a lifter provided on an outer circumference side of the housing. The lifter includes a fixed member fixed to the housing side, the mounting member configured to have a variable mounting position in a front-rear direction relative to the fixed member, and a bolt fixing the mounting member to the fixed member. The mounting member includes a mounting portion to which a foot pedal is attached, and fastening portions provided on both sides of the mounting portion in a left-right direction and fastened to the fixed member by a pair of the bolts on the left and right sides. The mounting method for the mounting member includes: attaching the mounting member to the fixed member by fastening the fastening portions with a pair of the bolts whose axial centers do not align.

### BRIEF DESCRIPTION OF THE DRAWINGS

FIG. 1 is a perspective view of the percussion instrument according to the first embodiment.

FIG. 2 is a perspective view of the percussion instrument, showing a state where the lifter is disassembled.

FIG. 3 is a partially enlarged front view of the percussion instrument, as viewed in the direction of arrow III in FIG. 1.

FIG. 4 is a partially enlarged cross-sectional view of the percussion instrument, taken along line IV-IV in FIG. 3.

FIG. 5 is an exploded perspective view of the attachment.

FIG. 6 is an exploded perspective view of the percussion instrument.

FIG. 7 is a partially enlarged cross-sectional view of the percussion instrument.

FIG. 8 is a partially enlarged cross-sectional view of the percussion instrument, showing a state where the striking surface of the attachment is hit by the beater from the state in FIG. 4.

FIG. 9A is a partially enlarged front view of the percussion instrument according to the second embodiment, and FIG. 9B is a partially enlarged front view of the percussion instrument according to the third embodiment.

FIG. 10 is an exploded perspective view of the percussion instrument according to the fourth embodiment.

FIG. 11 is a partially enlarged cross-sectional view of the percussion instrument.

### DESCRIPTION OF THE EMBODIMENTS

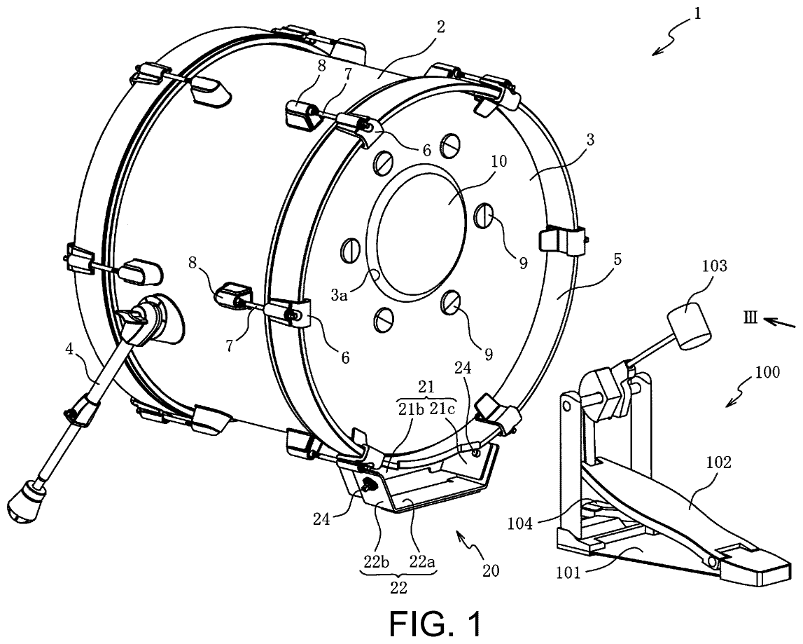

Exemplary embodiments will be described hereinafter with reference to the attached drawings. First, the overall configuration of a percussion instrument 1 according to the first embodiment will be described with reference to FIG. 1. FIG. 1 is a perspective view of the percussion instrument 1 according to the first embodiment.

In the following description, the side of the percussion instrument 1 closer to the performer when viewed from the performer's side is referred to as the front (front side) of the percussion instrument 1, and the opposite side is referred to as the rear of the percussion instrument 1. Additionally, the left side when viewed from the performer's side is referred to as the left side of the percussion instrument 1, and the opposite side is referred to as the right side of the percussion instrument 1.

As shown in FIG. 1, the percussion instrument 1 is a bass drum in which an opening portion at the front end (axial end portion) of a cylindrical shell 2 is closed with a head 3. A rod-shaped stand 4 that inclines downward toward the rear side of the shell 2 is attached to the outer circumferential surface of the shell 2 (body portion). The stand 4 is provided in a pair on the side surface on both the left and right sides of the shell 2, and this pair of stands 4 support the rear end portion of the shell 2 on the installation surface.

The head 3 is formed into a disc shape using a synthetic resin film and is attached to the shell 2 by a ring-shaped hoop 5. C-shaped (U-shaped) mounting fittings 6 are hooked on the hoop 5 at multiple locations in the circumferential direction. Through holes (not shown) are formed in the portions of the mounting fittings 6 that are positioned on the outer circumference side of the hoop 5, and tension bolts 7 are inserted into these through holes. Multiple lugs 8 arranged in the circumferential direction are provided on the outer circumferential surface of the shell 2. By screwing the tension bolts 7 into the lugs 8 while hooking the outer edge of the head 3 on the hoop 5, tension is applied to the head 3.

An attachment 10 is fixed to the head 3 by multiple fasteners 9. The detailed configuration of this fixing structure using the fasteners 9 and the attachment 10 will be described later, but the attachment 10 is fitted into a circular through hole 3a formed in the head 3, and this attachment 10 is to be hit by a foot pedal 100.

The foot pedal 100 includes a base plate 101 that is installed on the installation surface, and a foot board 102 is pivotally supported at the base end portion (end portion on the performer's side) of this base plate 101. When the performer steps on the foot board 102, a beater 103 rotates to hit (performance of the percussion instrument 1) the attachment 10. A clamp 104 is provided on the tip side of the base plate 101, and when the performer performs with the percussion instrument 1, this clamp 104 is attached to a lifter 20 of the percussion instrument 1.

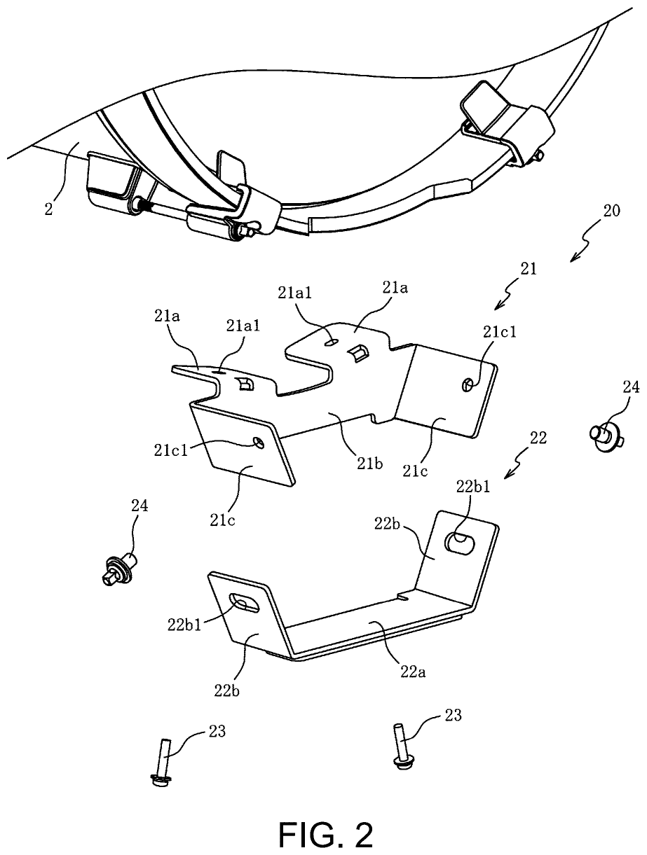

Next, the detailed configuration of the lifter 20 will be described with reference to FIG. 1 and FIG. 2. FIG. 2 is a perspective view of the percussion instrument 1, showing a state where the lifter 20 is disassembled.

As shown in FIG. 1 and FIG. 2, the lifter 20 includes a fixed member 21 fixed to the shell 2, and a mounting member 22 attached to the fixed member 21. Each of the fixed member 21 and the mounting member 22 (lifter 20) has a left-right symmetrical shape.

The fixed member 21 includes a pair of fixed portions 21a (see FIG. 2) spaced apart on the left and right (in the circumferential direction of the outer circumferential surface of the shell 2). The fixed portion 21a is formed into a rectangular flat plate shape, and a through hole 21a1 is formed in the center of the fixed portion 21a. A bolt 23 inserted into the through hole 21a1 is fastened to the shell 2, thereby attaching the fixed member 21 (a pair of fixed portions 21a) to the shell 2. Although not shown in the figure, a resin spacer is sandwiched between the fixed portion 21a and the outer circumferential surface of the shell 2.

A hanging portion 21b hangs downward from the front end side (end portion on the performer's side) of the pair of fixed portions 21a, and bent portions 21c are bent toward the front side from both the left and right ends of the hanging portion 21b. A female threaded hole 21c1 is formed on the front end side (front side with respect to the center in the front-rear direction) of the bent portion 21c, and the mounting member 22 is attached to the fixed member 21 by a bolt 24 that is fastened to the female threaded hole 21c1 (see FIG. 1 for this mounting state).

The mounting member 22 includes a mounting portion 22a extending in the horizontal direction, and a pair of fastening portions 22b bent upward from both the left and right ends of the mounting portion 22a. A long hole 22b1 (see FIG. 2) extending in the front-rear direction is formed in the fastening portion 22b, and the mounting member 22 is fixed to the fixed member 21 by fastening the bolt 24 inserted into the long hole 22b1 to the female threaded hole 21c1 of the fixed member 21. On the other hand, by sliding the fastening portion 22b (mounting member 22) along the long hole 22b1 while the bolt 24 is loosened, the fastening position of the fastening portion 22b relative to the bent portion 21c can be adjusted in the front-rear direction.

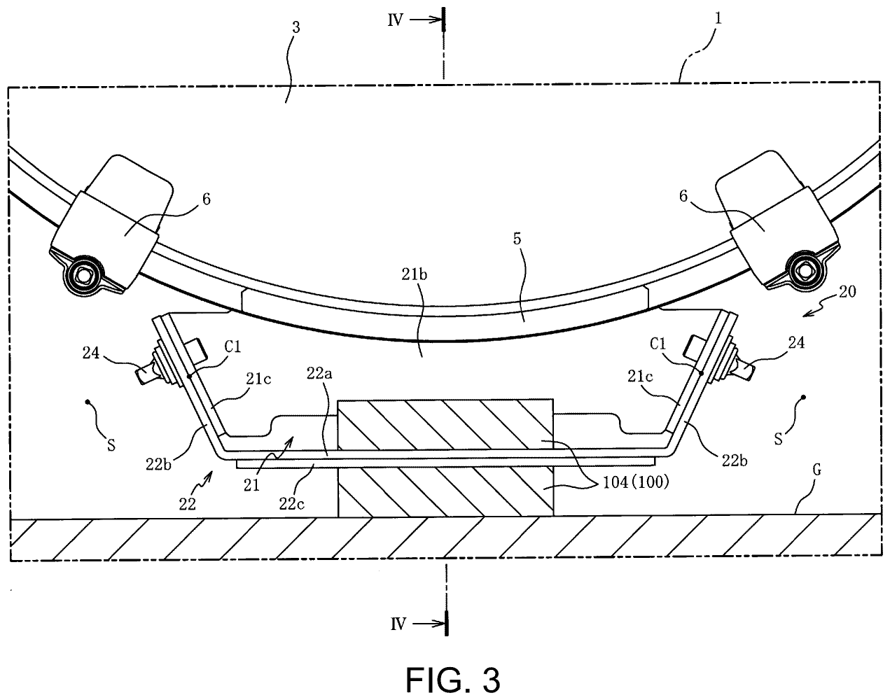

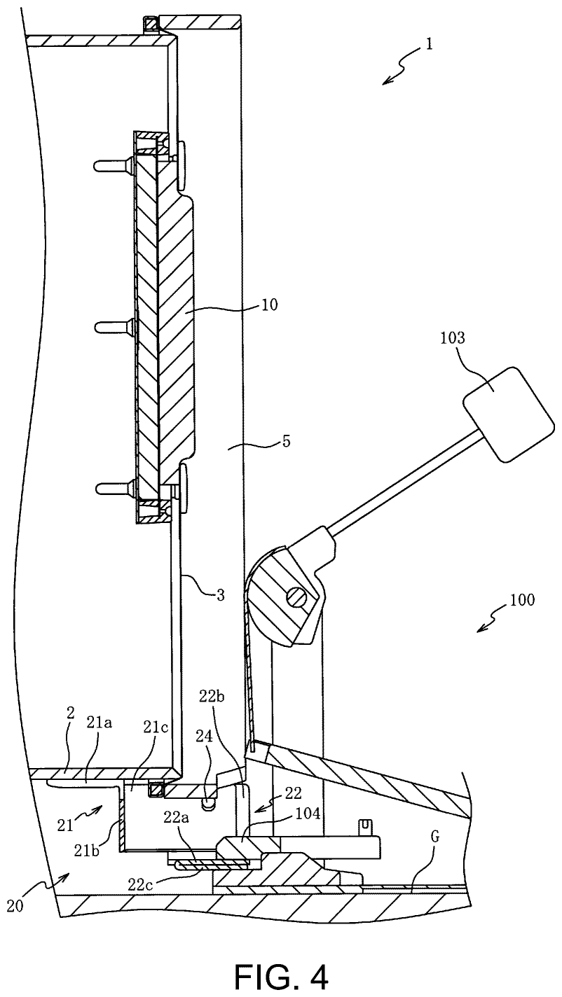

Next, a case where the foot pedal 100 is attached to the lifter 20 will be described with reference to FIG. 3 and FIG. 4. FIG. 3 is a partially enlarged front view of the percussion instrument 1, as viewed in the direction of arrow III in FIG. 1, and FIG. 4 is a partially enlarged cross-sectional view of the percussion instrument 1, taken along line IV-IV in FIG. 3.

Additionally, in FIG. 3, the shape of the clamp 104 of the foot pedal 100 that grasps the mounting member 22 (mounting portion 22a) is schematically illustrated and shown with hatching. Moreover, in FIG. 4, the illustration of the mounting fittings 6 (see FIG. 3) of the hoop 5 is omitted.

As shown in FIG. 3 and FIG. 4, in the case where the foot pedal 100 is attached to the percussion instrument 1, the mounting portion 22a is sandwiched from above and below by the clamp 104. In the state where the foot pedal 100 is attached to the mounting portion 22a, the front end portion of the percussion instrument 1 is supported on the installation surface G such as the floor via the foot pedal 100. As mentioned above, the rear end side of the percussion instrument 1 is supported on the installation surface G by the stands 4 (see FIG. 1).

When attaching the foot pedal 100 to the mounting portion 22a, the foot pedal 100 may interfere with the percussion instrument 1 (head 3 or hoop 5), or the impact position of the beater 103 (see FIG. 4) may not be appropriate. In such cases, an operation is performed to adjust the relative position between the percussion instrument 1 and the foot pedal 100 in the front-rear direction by loosening the bolt 24 and sliding the fastening portion 22b back and forth relative to the bent portion 21c.

As the related technology for this type of percussion instrument 1, there is known a technique of fastening the bolt from the lower surface side of the mounting member (for example, drum connection member 23 in Japanese Patent Application Laid-Open No. 2014-071196) to which the foot pedal is attached. However, according to this related technology, it is necessary to insert a hand (or tool) into the narrow space between the installation surface and the lifter, or to turn the percussion instrument upside down when performing the fastening operation of the bolt. Therefore, adjusting the relative position between the percussion instrument and the foot pedal requires considerable effort.

In contrast, according to this embodiment, the fastening portions 22b are provided on both sides in the left-right direction of the mounting portion 22a to which the foot pedal 100 is attached, and these fastening portions 22b are fastened to the fixed member 21 (bent portions 21c) by the bolts 24. As a result, even when the percussion instrument 1 is installed on the installation surface G, the fastening operation of the bolt 24 can be performed utilizing the relatively wide space S (see FIG. 3) formed on both the left and right sides (lateral sides of the lifter 20) of the mounting portion 22a. In other words, the relative position between the percussion instrument 1 and the foot pedal 100 can be easily adjusted without turning the percussion instrument 1 upside down.

In a state where the fixed member 21 and the mounting member 22 are fastened by the bolts 24, the side surface of the bent portion 21c facing the outer side in the left-right direction comes into contact with the side surface of the fastening portion 22b facing the inner side in the left-right direction. Hereinafter, these respective side surfaces are referred to as “fastening surfaces”, and the fastening surfaces of the bent portion 21c and the fastening portion 22b on the left side of the lifter 20, together with the fastening surfaces of the bent portion 21c and the fastening portion 22b on the right side, are collectively referred to and described as “left and right fastening surfaces” and so on.

In this embodiment, the left and right fastening surfaces are inclined with respect to the vertical direction. However, for example, even if the left and right fastening surfaces are planes along the vertical direction, it is possible to perform the fastening operation of the bolt 24 by utilizing the wide space S (see FIG. 3) on both sides of the lifter 20.

However, if the left and right fastening surfaces of the lifter 20 are configured as planes along the vertical direction (with the left and right fastening surfaces facing each other in parallel), the axial centers of the left and right bolts 24 align (line up in a straight line), which may cause the mounting member 22 to rotate around the bolts 24 due to vibration generated when the foot pedal 100 is stepped on.

When the mounting member 22 rotates around the bolts 24 as an axis, the relative position between the percussion instrument 1 and the foot pedal 100 may shift during performance, which degrades the playability of the percussion instrument 1. Additionally, when the mounting member 22 rotates around the bolts 24 as an axis, the bolts 24 may loosen, making it easier for rattling to occur between the mounting member 22 and the fixed member 21. This also leads to a decrease in the playability of the percussion instrument 1.

In order to suppress such rotation of the mounting member 22, it is also considered to fasten each of the left and right fastening surfaces with two bolts 24 (providing a total of four bolts 24 on the left and right fastening surfaces). However, in a configuration where multiple bolts 24 are provided on the left and right fastening surfaces, the fastening operation of the bolt 24 requires considerable effort, and the lifter 20 becomes larger in size.

In contrast, according to this embodiment, the left and right fastening surfaces of the lifter 20 are non-parallel to the vertical direction, and the left and right bolts 24 fasten the fastening portions 22b at positions where the respective axial centers do not align. In other words, the axial centers of the bolts 24, each provided on the left and right fastening surfaces, do not line up in a straight line.

Thus, the rotation of the mounting member 22 relative to the fixed member 21 (rotation of the mounting member 22 around the bolts 24 as an axis) can be regulated by the engagement between the bolts 24 and the fastening portions 22b, or by the engagement between the left and right fastening surfaces (bent portion 21c and fastening portion 22b). Therefore, it is possible to suppress the relative position between the percussion instrument 1 and the foot pedal 100 from shifting during performance, thus improving the playability of the percussion instrument 1. Additionally, since the mounting member 22 does not rotate around the bolts 24 as an axis, it is possible to suppress the loosening of the bolts 24 due to such rotation. As it becomes difficult for rattling to occur between the fixed member 21 (bent portion 21c) and the mounting member 22, the playability of the percussion instrument 1 can be improved.

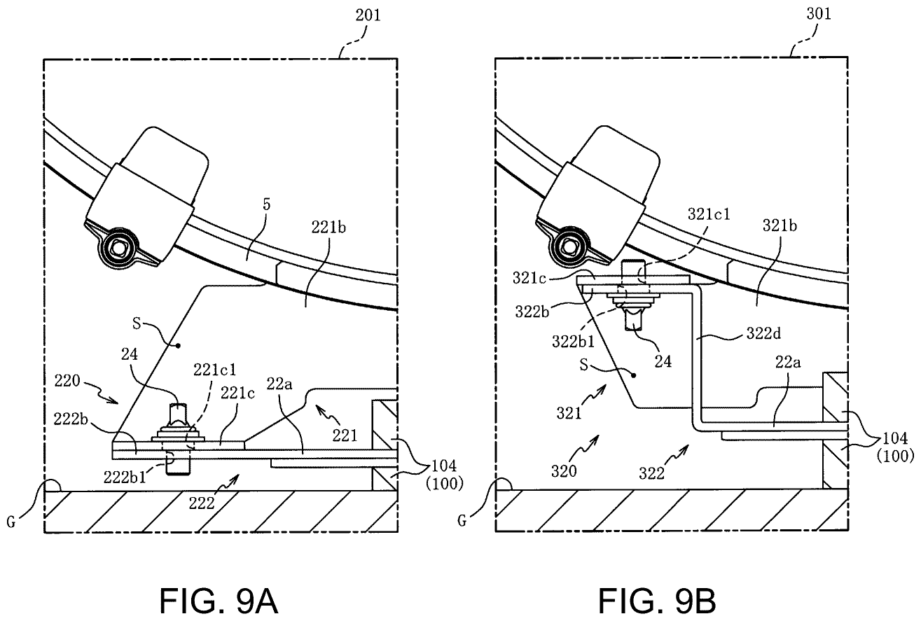

Here, a percussion instrument 201 of the second embodiment and a percussion instrument 301 of the third embodiment (see FIG. 9A and FIG. 9B), which will be described later, are illustrated as other examples of the configuration that can facilitate the fastening operation of the bolt 24. Details will be described later, but in the percussion instrument 201 of the second embodiment (see FIG. 9A), the fastening operation of the bolt 24 is performed utilizing the space S between the hoop 5 and the bent portion 221c, and in the percussion instrument 301 of the third embodiment (see FIG. 9B), the fastening operation of the bolt 24 is performed utilizing the space S between the fastening portion 322b and the installation surface G.

However, in the configuration where the bolt 24 is fastened in the up-down direction, as in the percussion instrument 201 of the second embodiment and the percussion instrument 301 of the third embodiment, the hoop 5 and the installation surface G may interfere with the hand or tool performing the fastening operation of the bolt 24.

In contrast, according to this embodiment, the left and right fastening surfaces (fastening portions 22b) of the lifter 20 incline upward from the mounting portion 22a toward the outer side in the left-right direction (see FIG. 3), making it possible to fasten the bolt 24 from the lateral side of the fastening portion 22b. Thus, compared to the percussion instrument 201 of the second embodiment and the percussion instrument 301 of the third embodiment, the hoop 5 and the installation surface G are less likely to interfere with the hand or tool performing the fastening operation of the bolt 24. Therefore, the workability of the fastening operation of the bolt 24 can be improved.

Furthermore, the axial center of the bolt 24 is positioned above the vertical center C1 of the left and right fastening surfaces. That is, since the bolt 24 fastens the fixed member 21 (bent portion 21c) and the fastening portion 22b above the vertical center C1 of the fastening surface, compared to the case where the bolt 24 is provided below the vertical center C1 of the fastening surface, for example, it becomes less likely for the installation surface to interfere with the hand or tool performing the fastening operation of the bolt 24. This can also improve the workability of the fastening operation of the bolt 24.

In addition, according to this embodiment, the inclination angle of the left and right fastening surfaces (bent portion 21c and fastening portion 22b) with respect to the vertical direction is 25°, but this inclination angle of the fastening surface is preferably 5° or more and 40° or less. Within this angle range, interference of the percussion instrument 1 or the installation surface with the hand or tool performing the fastening operation of the bolt 24 can be suppressed. Furthermore, the inclination angle of the left and right fastening surfaces is more preferably 15° or more and 30° or less, and within this angle range, interference of the percussion instrument 1 or the installation surface with the hand or tool performing the fastening operation of the bolt 24 can be suppressed more effectively.

After fastening the fixed member 21 and the mounting member 22 with the bolt 24, the percussion instrument 1 is played by stepping on the foot pedal 100. During this performance, a vertical load (vibration) is likely to act on the mounting portion 22a to which the foot pedal 100 is attached. When a load during performance repeatedly acts on the mounting portion 22a, the bolt 24 may loosen.

That is, as mentioned above, the lifter 20 of this embodiment is configured to generally prevent the rotation of the mounting member 22 around the bolt 24 as an axis. However, when a load during performance repeatedly acts on the mounting portion 22a (mounting member 22), the bolt 24 may gradually loosen.

In contrast, according to this embodiment, the bent portion 21c (fixed member 21) is fastened to the inner side in the left-right direction of the fastening portion 22b, so that even if the bolt 24 loosens or falls off, the bent portion 21c (fixed member 21) can be retained inside the left and right fastening portions 22b. In other words, even if the bolt 24 falls off during performance, the mounting member 22 can maintain the state of supporting the fixed member 21 from below, so that the performance of the percussion instrument 1 can be continued.

Also, since a load during performance is likely to act on the mounting portion 22a, in this embodiment, a reinforcing portion 22c is stacked (joined) on the lower surface of the mounting portion 22a to ensure the rigidity of the mounting portion 22a. The mounting portion 22a and the reinforcing portion 22c are integrally formed by bending a single metal plate (as shown in FIG. 4, folding back the reinforcing portion 22c from the rear end portion of the mounting portion 22a to the lower surface side of the mounting portion 22a). Similarly, the mounting portion 22a and the fastening portion 22b are also integrally formed by bending a metal plate, so that the mounting member 22 having these portions 22a to 22c can be easily formed from a single metal plate.

A load during performance also acts on the fixed member 21 via the mounting member 22. In this case, as in the percussion instrument 201 of the second embodiment and the percussion instrument 301 of the third embodiment (see FIG. 9A and FIG. 9B), which will be described later, with the structure where the bent portions 221c and 321c are bent from the lower end portion or upper end portion of the hanging portions 221b and 321b, the load when the foot pedal 100 is stepped on acts in the plate thickness direction of the bent portions 221c and 321c. Therefore, bending is likely to occur in the bent portions 221c and 321c, or deformation is likely to occur in the bent portion between the hanging portions 221b and 321b and the bent portions 221c and 321c.

In other words, in the configurations of the second and third embodiments to be described later, the rigidity of the fixed members 221 and 321 against the load acting from the foot pedal 100 decreases, making it easier for the relative position between the percussion instrument 1 and the foot pedal 100 to shift during performance.

In contrast, according to this embodiment, the fastening portion 22b is fastened to the bent portion 21c that is bent toward the front side from both the left and right ends of the hanging portion 21b (the plate surface of the bent portion 21c is directed to the left and right), making it possible to suppress the vertical load during performance from acting in the plate thickness direction of the bent portion 21c (the bending direction of the bent portion 21c with respect to the hanging portion 21b). This can suppress the occurrence of bending in the bent portion 21c or deformation in the bent portion between the hanging portion 21b and the bent portion 21c. In other words, the rigidity of the fixed member 21 against the load acting from the foot pedal 100 can be improved, making it difficult for the relative position between the percussion instrument 1 and the foot pedal 100 to change during performance. Therefore, the playability of the percussion instrument 1 can be improved.

Moreover, since the fixed portion 21a, the hanging portion 21b, and the bent portion 21c constituting the fixed member 21 are integrally formed by bending a metal plate, the fixed member 21 can be easily formed from a single metal plate.

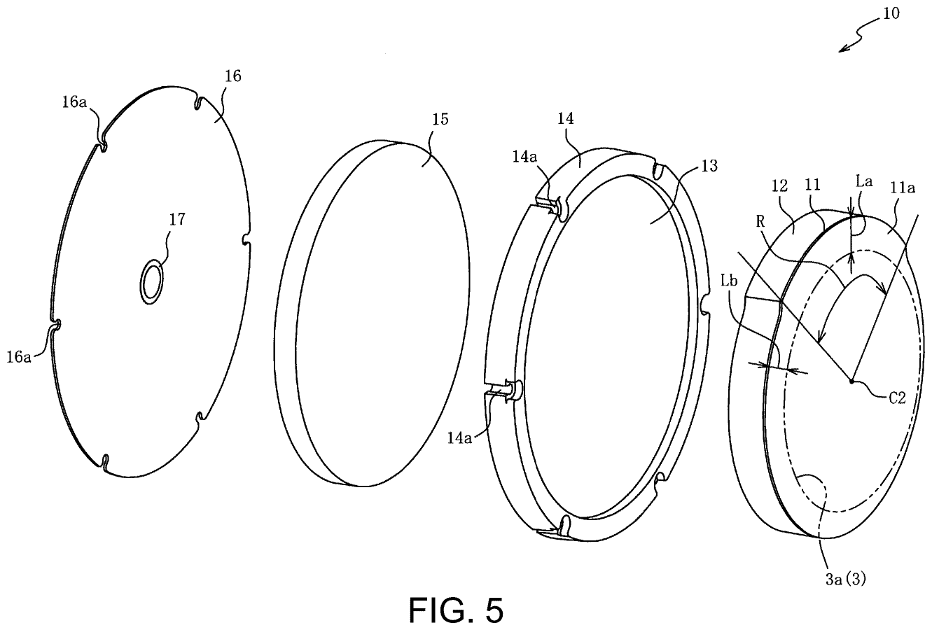

Next, the configuration of the attachment 10 to be hit by the beater 103 (see FIG. 4) during performance of the percussion instrument 1 will be described with reference to FIG. 5. FIG. 5 is an exploded perspective view of the attachment 10.

As shown in FIG. 5, the attachment 10 includes a disc-shaped membrane member 11 whose front surface serves as a striking surface 11a. A cushion 12 for absorbing impact of the hit on the striking surface 11a is adhered to the rear surface of the membrane member 11.

The membrane member 11 is formed into a membrane shape using a mesh-like material (mesh) woven from synthetic fibers, but the material of the membrane member 11 may be any material that is harder (has higher hardness) than the cushion 12. Therefore, for example, the membrane member 11 may also be formed using a synthetic resin film. The cushion 12 is formed into a disc shape thicker than the membrane member 11, and the diameters of the membrane member 11 and the cushion 12 are the same. That is, the outer shapes (shapes when viewed in the front-rear direction) of the membrane member 11 and the cushion 12 are the same.

The cushion 12 is formed using a foamed synthetic resin such as polyurethane foam. However, as long as the cushion 12 has a predetermined flexibility, the cushion 12 may be formed using rubber, resins such as elastomer (synthetic resin), or foam materials using these resins (hereinafter referred to as “elastic materials”).

The rear surface of the cushion 12 is supported by a support membrane 13. The support membrane 13 is formed into a disc shape using a mesh woven from synthetic fibers or a synthetic resin film, and a ring-shaped frame 14 is fixed to the outer edge of the support membrane 13. The frame 14 is formed using a resin material, and the support membrane 13 and the frame 14 are integrally formed by mold forming. Alternatively, the frame 14 may be formed using a material other than resins (for example, metals such as aluminum and iron), and joined to the support membrane 13 by adhesion or the like.

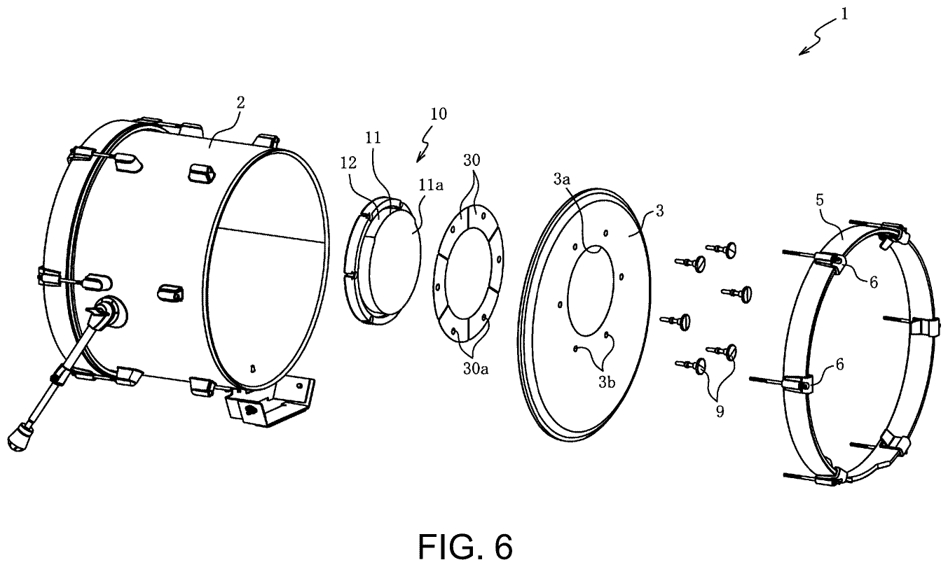

Multiple press-fit holes 14a (in this embodiment, at six locations) are formed at equal intervals in the circumferential direction on the outer edge of the frame 14. These press-fit holes 14a are holes into which the fasteners 9 (see FIG. 6), which will be described later, are fitted.

A disc-shaped cushion 15 formed using an elastic material is stacked on the rear surface of the support membrane 13, and a mounting plate 16 is stacked on the rear surface of the cushion 15. The mounting plate 16 is formed into a disc shape using a resin or metal material, and a disc-shaped sensor 17 (piezoelectric element) is attached to the center of the mounting plate 16 by a cushioning double-sided tape.

Multiple press-fit holes 16a are formed on the outer edge of the mounting plate 16 at positions corresponding to the press-fit holes 14a of the frame 14. The attachment 10 is attached to the head 3 by the fasteners 9 (see FIG. 6) that are press-fitted into these press-fit holes 14a and 16a.

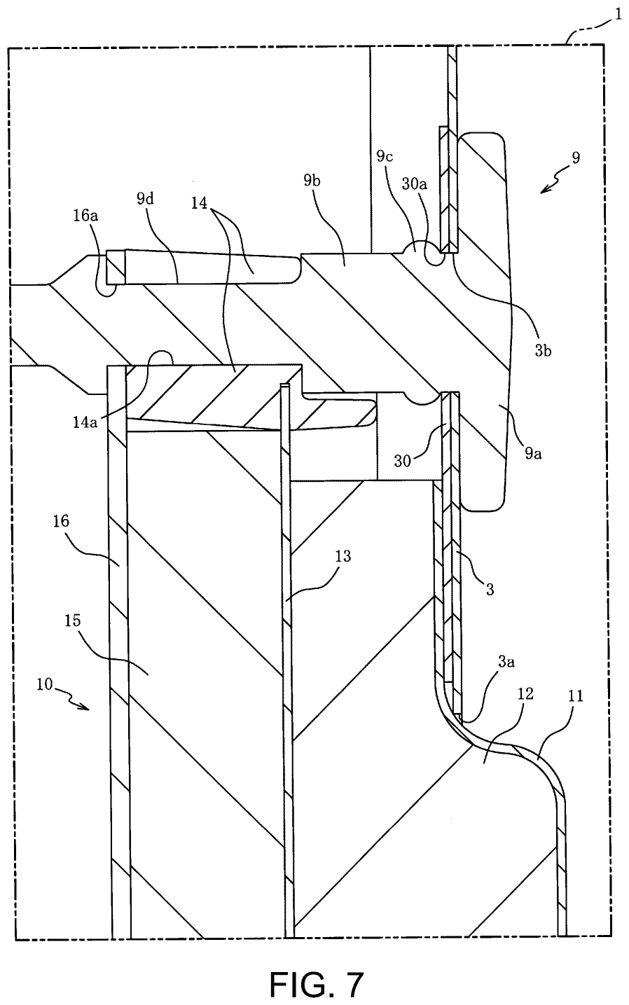

The mounting structure of this attachment 10 will be described with reference to FIG. 6 and FIG. 7. FIG. 6 is an exploded perspective view of the percussion instrument 1, and FIG. 7 is a partially enlarged cross-sectional view of the percussion instrument 1. It should be noted that FIG. 7 illustrates a cross-section cut through a plane including the axis of the fastener 9.

As shown in FIG. 6, the head 3 of the percussion instrument 1 is attached to the shell 2 by the hoop 5 and the mounting fittings 6 as described above, and a through hole 3a is formed in the head 3 for fitting the membrane member 11 and the cushion 12 of the attachment 10.

Around the through hole 3a, multiple (in this embodiment, 6) press-fit holes 3b are formed at equal intervals in the circumferential direction, and the fasteners 9 are press-fitted into the press-fit holes 3b. The fasteners 9 are pins made of elastomer or rubber.

In addition, multiple (in this embodiment, 6 pieces) resin plates 30 are joined to the rear surface of the head 3 to reinforce the area surrounding the through hole 3a. The multiple plates 30 are formed by equally dividing a ring-shaped film in the circumferential direction. That is, each of the multiple plates 30 is formed into a fan shape, and the through hole 3a is surrounded entirely by these multiple fan-shaped plates 30. The plate 30 is formed with a press-fit hole 30a for press-fitting the fastener 9.

As shown in FIG. 7, the fastener 9 includes a disc-shaped head portion 9a and a shaft portion 9b protruding in the thickness direction (rear side) of the head portion 9a. The diameter of the head portion 9a is formed larger than the diameter of the press-fit hole 3b of the head 3.

The shaft portion 9b is formed with a protrusion 9c for hooking the head 3 and the plate 30, and a groove 9d for hooking the press-fit hole 14a of the frame 14 and the press-fit hole 16a of the mounting plate 16. The protrusion 9c is an annular protrusion that extends in the circumferential direction of the shaft portion 9b. A gap corresponding to the membrane thickness of the head 3 and the plate 30 is formed between the head portion 9a and the protrusion 9c, and the outer diameter of the protrusion 9c is formed slightly larger than the diameter of the press-fit hole 3b of the head 3 and the press-fit hole 30a of the plate 30. Therefore, by press-fitting the protrusion 9c into the press-fit holes 3b and 30a, the head 3 and the plate 30 are hooked between the head portion 9a and the protrusion 9c.

The groove 9d is an annular recess that extends in the circumferential direction of the shaft portion 9b, and in the region where the groove 9d is formed, the diameter of the shaft portion 9b is formed to be the same as the inner diameter of the press-fit hole 14a of the frame 14 and the press-fit hole 16a of the mounting plate 16. Therefore, by press-fitting the shaft portion 9b into the press-fit holes 14a and 16a, the frame 14 and the mounting plate 16 are hooked into the groove 9d. As a result, the attachment 10 is attached to the rear surface of the head 3 by the fasteners 9.

In the mounting state of this attachment 10, the support membrane 13, the frame 14, the cushion 15, and the mounting plate 16 constitute a support body that supports the membrane member 11 and the cushion 12 on the rear surface side of the head 3. Then, the membrane member 11 and the cushion 12 interposed between this support body and the head 3 are pressed against the peripheral part of the through holes 3a of the head 3 via the plates 30, which achieves a configuration that can improve the durability of the membrane member 11 and the cushion 12.

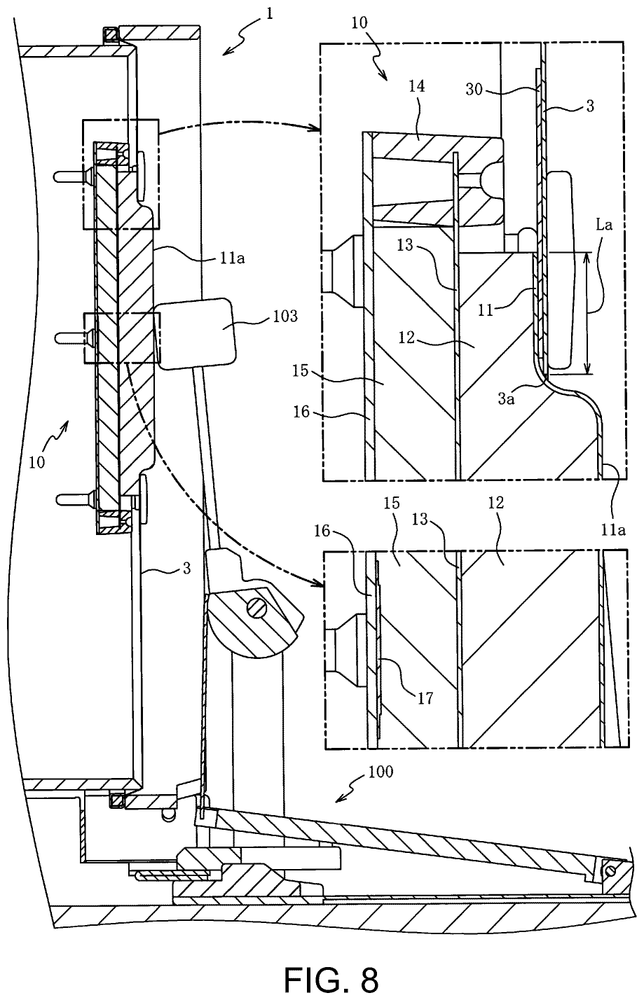

The detailed configuration of this attachment 10 will be described with reference to FIG. 8. FIG. 8 is a partially enlarged cross-sectional view of the percussion instrument 1, showing a state where the striking surface 11a of the attachment 10 is hit by the beater 103 from the state in FIG. 4.

As shown in FIG. 8, the membrane member 11 (striking surface 11a) of the attachment 10 is hit by the beater 103 of the foot pedal 100, and the impact at the time of hitting is absorbed by the cushion 12. Therefore, the striking sound generated at the time of hitting the membrane member 11 can be reduced.

In the related technology for this type of percussion instrument 1 (for example, International Publication No. 2017/038226), in the case where the membrane member 11 is hit, a deformation occurs in which the outer edge portion of the cushion 12 expands (the thickness increases), resulting in problems such as peeling occurring at the adhesion portion between the membrane member 11 and the cushion 12, or cracks forming on the outer circumferential surface of the cushion 12.

In contrast, according to this embodiment, the outer edge portion of the membrane member 11 and the cushion 12 is arranged to overlap with the peripheral part of the through holes 3a of the head 3 in the front-rear direction (the striking surface 11a is formed by the portion of the membrane member 11 positioned on the inner circumference side of the through holes 3a of the head 3). Thus, in the case where the membrane member 11 is hit by the beater 103, the expansion deformation of the outer edge of the cushion 12 can be regulated by the head 3. Therefore, it is possible to suppress the occurrence of peeling at the adhesion portion between the membrane member 11 and the cushion 12, or the occurrence of cracks on the outer circumferential surface of the cushion 12. Consequently, the durability of the striking surface 11a (the hit body composed of the membrane member 11 and the cushion 12) can be improved.

Furthermore, in the state where the attachment 10 is attached to the head 3, the gap between the head 3 (plate 30) and the support membrane 13 is formed to be smaller than the thickness of the membrane member 11 and the cushion 12. Therefore, in a state before the striking surface 11a is hit, the outer edge portion of the cushion 12 is compressed by the head 3. As a result, the expansion deformation of the outer edge portion of the cushion 12 can be effectively suppressed, thereby improving the durability of the membrane member 11 and the cushion 12.

Moreover, since the outer edge portion of the cushion 12 is compressed by the head 3, in addition to the function of attaching the attachment 10, the head 3 can also have the function of regulating the expansion of the outer edge of the cushion 12.

In addition, multiple plates 30 that are harder (higher hardness) than the head 3 (membrane member 11) are sandwiched between the head 3 and the membrane member 11. These multiple plates 30 are arranged in a ring shape around the through hole 3a, so the expansion deformation of the outer edge of the cushion 12 can be uniformly regulated over the entire circumference of the cushion 12. Therefore, the durability of the membrane member 11 and the cushion 12 can be improved. Furthermore, the compression amount of the cushion 12 can be adjusted by changing the thickness of the plate 30.

Furthermore, since multiple plates 30 are attached around the through hole 3a of the head 3, the rigidity of the head 3 can be enhanced by the plates 30. As a result, damage to the head 3 that presses down on the membrane member 11 and the cushion 12 can be suppressed, and the expansion deformation of the outer edge of the cushion 12 can be effectively regulated by the head 3 and the plates 30. Therefore, the durability of the head 3, the membrane member 11, and the cushion 12 can be improved.

Thus, in the case of aiming to enhance the rigidity around the through hole 3a with the plates 30, it is also possible to, for example, integrally form multiple plates 30 and attach a single ring-shaped plate 30 around the through hole 3a of the head 3. However, with such a configuration, it becomes easier for the plate 30 to bend, making it difficult to properly attach the plate 30 to the head 3.

Also, in a configuration where a single ring-shaped plate 30 is cut out from a resin plate used as the material, the number of plates 30 that can be cut out from the resin plate decreases (all the resin plate cut off on the inner circumference side of the ring-shaped plate 30 becomes waste material). Therefore, the manufacturing cost of the plate 30 increases.

In contrast, according to this embodiment, multiple (annular fan-shaped) plates 30 are arranged in a ring shape around the through hole 3a. Thus, compared to the case where a single plate 30 is formed into a ring shape as described above, the bending of the plates 30 can be suppressed, allowing the plates 30 to be appropriately attached to the head 3. Therefore, the workability of the attaching operation for the plates 30 can be improved.

Furthermore, when cutting out multiple (annular fan-shaped) plates 30 from the resin plate used as the material, it is possible to cut out a larger number of plates 30 from the resin plate (thereby reducing the amount of waste resin plate), compared to the case of cutting out a single ring-shaped plate 30 as described above. Therefore, the manufacturing cost of the plates 30 can be reduced.

When the membrane member 11 (striking surface 11a) is hit, the vibration is detected by the sensor 17 attached to the mounting plate 16, and a musical sound signal based on the detection result is generated by a sound source (not shown). The musical sound signal generated by the sound source is output to an amplifier and a speaker (both not shown), thereby emitting an electronic musical sound from the speaker.

Thus, when detecting a hit on the striking surface 11a with the sensor 17, the related technology mentioned above (for example, International Publication No. 2017/038226) has the following problem for there is no member compressing the outer edge of the cushion 12 as in this embodiment.

In other words, in a configuration where the outer edge of the cushion 12 is not compressed, deformation is more likely to occur (impact absorption capacity increases) on the outer edge side of the cushion 12 than near the center of the cushion 12. Therefore, in the case where the outer circumference side of the striking surface 11a (membrane member 11) is hit, the output value of the sensor 17 tends to be smaller compared to the case where the central area of the striking surface 11a is hit. That is, the sensitivity distribution of the sensor 17 to hits on the striking surface 11a becomes non-uniform.

If the sensitivity distribution of the sensor 17 is non-uniform, when the performer hits the striking surface 11a with a twin pedal type foot pedal 100, different musical sounds (for example, sounds with different volumes) are more likely to be generated at the time of impact by the left and right beaters 103. In order to eliminate such a malfunction in musical sound generation, it is necessary to finely adjust the mounting position of the foot pedal 100 to the left or right relative to the percussion instrument 1 so that the center (sensor 17) of the striking surface 11a is positioned between the left and right beaters 103. Therefore, there is a problem that the mounting operation of the foot pedal 100 requires considerable effort.

In contrast, according to this embodiment, the outer edge of the cushion 12 is compressed, making it difficult for differences in ease of deformation (impact absorption capacity) to occur between the central area and the outer edge side of the cushion 12. As a result, the sensitivity distribution of the sensor 17 to hits on the striking surface 11a (membrane member 11) can be made uniform. Therefore, for example, when using a twin pedal type foot pedal 100, it is easy to generate an appropriate musical sound even if the mounting position of the foot pedal 100 (impact positions of the left and right beaters 103) is shifted to the left or right relative to the center of the striking surface 11a. In other words, there is no need to finely adjust the mounting position of the foot pedal 100 to the left or right relative to the percussion instrument 1, which makes the mounting operation of the foot pedal 100 easier.

Thus, in the case of detecting a hit on the membrane member 11 using the sensor 17 attached to the mounting plate 16, it is also possible to omit the cushion 15, for example. That is to say, the attachment 10 of this embodiment includes a membrane-like support membrane 13 stacked on the rear surface side of the cushion 12, and a frame 14 connected to the outer edge of this support membrane 13, with the mounting plate 16 attached to this frame 14. Therefore, even if the cushion 15 is omitted, for example, the vibration generated when the membrane member 11 is hit can be transmitted to the sensor 17 via the cushion 12, the support membrane 13, the frame 14, and the mounting plate 16.

However, if the cushion 15 is omitted, when the vibration transmitted from the frame 14 causes the mounting plate 16 itself to vibrate, it is not possible to quickly attenuate the vibration of the mounting plate 16. In the case where the attenuation of the vibration of the mounting plate 16 is slow, the vibration may be erroneously detected by the sensor 17, and therefore, the sensor 17 cannot accurately detect a hit on the membrane member 11.

In contrast, according to this embodiment, the cushion 15 is provided to be sandwiched between the support membrane 13 and the mounting plate 16, so the vibration of the mounting plate 16 can be attenuated quickly by the cushion 15. As a result, the sensor 17 can detect a hit on the membrane member 11 with high accuracy.

While the cushion 15 is required to have the function of absorbing the vibration of the mounting plate 16, the cushion 12 also needs to have the function of absorbing the impact of a hit on the membrane member 11, as well as the function of providing a striking feel (similar to the striking feel of an acoustic drum) at the time of hitting the membrane member 11. Therefore, in this embodiment, the cushion 12 is formed using a foam material with a higher density (higher hardness) than the cushion 15. In this way, the cushion 12 can absorb the impact of a hit on the membrane member 11 while improving the striking feel at the time of hitting the membrane member 11.

On the other hand, since the striking feel at the time of hitting the membrane member 11 can be generally ensured by the cushion 12 and the support membrane 13, the cushion 15 is not required for the function of providing a striking feel, but mainly for the function of attenuating the vibration of the mounting plate 16. Thus, forming the cushion 15 from a low-density foam material can reduce the cost (and weight) of the cushion 15 while providing the necessary function (attenuating the vibration of the mounting plate 16) to the cushion 15.

Additionally, since the sensor 17 is sandwiched between the cushion 15 and the mounting plate 16, the sensitivity of the sensor 17 to a hit on the membrane member 11 can be improved (the maximum value of the output value of the sensor 17 can be increased) compared to the case where the sensor 17 is attached to the rear surface of the mounting plate 16. The reason is considered to be that part of the vibration from the hit on the membrane member 11 is transmitted to the sensor 17 via the cushion 12, the support membrane 13, and the cushion 15. As a result, the hit on the membrane member 11 can be accurately detected by the sensor 17.

Here, the hit from the beater 103 is often in a direction inclined downward toward the rear lower side of the percussion instrument 1 (direction toward the lower left in FIG. 8), and when the membrane member 11 is hit in such a direction, the membrane member 11 and the cushion 12 are pushed (pulled) downward. Therefore, if the overlap margin La of the upper end side of the membrane member 11 with the head 3 is small, the outer edge of the membrane member 11 and the cushion 12 may be easily exposed (easily protrude) to the inner circumference side of the through hole 3a of the head 3 at the time of being hit by the beater 103.

In contrast, according to this embodiment, the configuration can suppress such exposure of the membrane member 11 and the cushion 12. This configuration will be described with reference back to FIG. 5. It should be noted that in FIG. 5, a circle corresponding to the through hole 3a of the head 3 is illustrated with a two-dot chain line.

As shown in FIG. 5, the radial dimension of the membrane member 11 and the cushion 12 based on the center C2 of the through hole 3a is formed to be largest in the region R on the upper end side of the membrane member 11 and the cushion 12. In other words, the overlap margin La between the head 3 and the membrane member 11 (cushion 12) in the region R including the upper edge of the membrane member 11 is formed to be larger than the overlap margin Lb in other regions. These overlap margins La and Lb indicate the range where the peripheral part of the through hole 3a of the head 3 overlaps with the membrane member 11 and the cushion 12 when viewed in the front-rear direction (when viewed in the thickness direction of the membrane member 11).

By increasing the overlap margin La with the head 3 in the region R including the upper edge of the membrane member 11 (cushion 12) in this way, the exposure (protrusion) of the outer edge of the membrane member 11 and the cushion 12 to the inner circumference side of the through hole 3a can be suppressed even when the membrane member 11 and the cushion 12 are pushed downward by the hit of the beater 103 (see FIG. 8). As such exposure of the membrane member 11 and the cushion 12 is suppressed, interference with the performance of the percussion instrument 1 can be prevented (for example, the operation of reattaching the attachment 10 to the head 3 can be unnecessary).

It should be noted that the dimension of the overlap margin La between the head 3 and the membrane member 11 (cushion 12), and the range in the circumferential direction of the region R where the overlap margin La is relatively large should be appropriately set to the extent that the membrane member 11 or the cushion 12 is not exposed to the inner circumference side of the through hole 3a when hit by the beater 103.

Next, the percussion instrument 201 of the second embodiment and the percussion instrument 301 of the third embodiment will be described with reference to FIG. 9A and FIG. 9B. The first embodiment described above illustrates a case where the bent portions 21c are formed on both the left and right end sides of the hanging portion 21b of the lifter 20. However, the second and third embodiments illustrate cases where bent portions 221c and 321c are respectively formed on both the upper and lower end sides of the hanging portions 221b and 321b. It should be noted that the same reference numerals are assigned to the same parts as in the first embodiment described above, and descriptions thereof will be omitted.

FIG. 9A is a partially enlarged front view of the percussion instrument 201 according to the second embodiment, and FIG. 9B is a partially enlarged front view of the percussion instrument 301 according to the third embodiment.

As shown in FIG. 9A, the lifter 220 of the percussion instrument 201 of the second embodiment includes a fixed member 221 that is fixed to the shell 2 (see FIG. 1), and a mounting member 222 that is attached to the fixed member 221. Each of the fixed member 221 and the mounting member 222 (lifter 220) has a left-right symmetrical shape.

The hanging portion 221b of the fixed member 221 has the same configuration as the hanging portion 21b (see FIG. 3) of the first embodiment, except for the point that both the left and right ends (for example, the end portion on the left side in FIG. 9A) are extended to incline downward toward the outer side in the left-right direction.

The bent portion 221c is bent toward the front side from the lower end portion of the hanging portion 221b which is positioned on the outer side in the left-right direction with respect to the mounting portion 22a. A long hole 221c1 extending in the front-rear direction is formed in the bent portion 221c, and a bolt 24 is inserted from above into this long hole 221c1.

The mounting member 222 has the same configuration as the mounting member 22 (see FIG. 3) of the first embodiment, except for the point that both the left and right ends (for example, the end portion on the left side in FIG. 9A) of the mounting portion 22a are extended toward the outer side in the left-right direction to serve as the fastening portions 222b. The fastening portion 222b is formed with a female threaded hole 222b1, and the mounting member 222 is fixed to the fixed member 221 by fastening the bolt 24 inserted through the long hole 221c1 of the fixed member 221 into the female threaded hole 222b1.

In this embodiment, the fastening portions 222b are also provided on both sides in the left-right direction of the mounting portion 22a to which the clamp 104 (foot pedal 100) is attached, and the fastening portion 222b is fastened to the fixed member 221 (bent portion 221c) by the bolt 24. As a result, even when the percussion instrument 201 is installed on the installation surface G, the fastening operation of the bolt 24 can be performed utilizing the relatively wide space S formed on both the left and right sides of the mounting portion 22a (between the bent portion 221c and the hoop 5). In other words, the relative position between the percussion instrument 201 and the foot pedal 100 can be easily adjusted without turning the percussion instrument 201 upside down.

Furthermore, the fastening surfaces between the bent portion 221c and the fastening portion 222b are planes extending in the horizontal direction, and although not shown in the figure, a pair of bolts 24 provided on the left and right fasten the fastening portions 222b at positions where the respective axial centers do not align. Thus, rotation of the mounting member 222 around the bolt 24 as an axis can be suppressed even when the vibration from the foot pedal 100 being stepped on acts on the mounting member 222. Therefore, it is possible to suppress the relative position between the percussion instrument 201 and the foot pedal 100 from shifting during performance, thus improving the playability of the percussion instrument 201. Furthermore, since the mounting member 222 does not rotate around the bolt 24 as an axis, it is possible to suppress the loosening of the bolt 24. Consequently, as rattling of the mounting member 222 relative to the fixed member 221 is less likely to occur, the playability of the percussion instrument 201 can be improved.

As shown in FIG. 9B, the lifter 320 of the percussion instrument 301 of the third embodiment includes a fixed member 321 that is fixed to the shell 2 (see FIG. 1), and a mounting member 322 that is attached to the fixed member 321. Each of the fixed member 321 and the mounting member 322 (lifter 320) has a left-right symmetrical shape.

The hanging portion 321b of the fixed member 321 has the same configuration as the hanging portion 21b (see FIG. 3) of the first embodiment, except for the point that both the left and right ends (for example, the end portion on the left side in FIG. 9B) are extended toward the outer side in the left-right direction.

The bent portion 321c is bent toward the front side from the upper end portion of the hanging portion 321b which is positioned on the outer side in the left-right direction with respect to the mounting portion 22a. A female threaded hole 321c1 is formed in the bent portion 321c, and a bolt 24 is fastened from below into the female threaded hole 321c1.

The mounting member 322 has the same configuration as the mounting member 22 (see FIG. 3) of the first embodiment, except for the point that the mounting member 322 includes a bent portion 322d that is bent upward from both the left and right ends (for example, the end portion on the left side in FIG. 9A) of the mounting portion 22a, and a fastening portion 322b that is bent toward the outer side in the left-right direction from the upper end of the bent portion 322d.

A long hole 322b1 extending in the front-rear direction is formed in the fastening portion 322b, and the mounting member 322 is fixed to the fixed member 321 by fastening the bolt 24 inserted through this long hole 322b1 into the female threaded hole 321c1 of the fixed member 321.

In this embodiment, the fastening portions 322b are also provided on both sides in the left-right direction of the mounting portion 22a to which the clamp 104 (foot pedal 100) is attached, and the fastening portion 322b is fastened to the fixed member 321 (bent portion 321c) by the bolt 24. As a result, even when the percussion instrument 301 is installed on the installation surface G, the fastening operation of the bolt 24 can be performed utilizing the relatively wide space S formed on both the left and right sides of the mounting portion 22a (between the fastening portion 322b and the installation surface G). In other words, the relative position between the percussion instrument 301 and the foot pedal 100 can be easily adjusted without turning the percussion instrument 301 upside down.

In addition, the fastening surfaces between the bent portion 321c and the fastening portion 322b are planes extending in the horizontal direction, and although not shown in the figure, a pair of bolts 24 provided on the left and right fasten the fastening portions 322b at positions where the respective axial centers do not align. Thus, rotation of the mounting member 322 around the bolt 24 as an axis can be suppressed even when the vibration from the foot pedal 100 being stepped on acts on the mounting member 322. Therefore, it is possible to suppress the relative position between the percussion instrument 301 and the foot pedal 100 from shifting during performance, thus improving the playability of the percussion instrument 301. Furthermore, since the mounting member 322 does not rotate around the bolt 24 as an axis, it is possible to suppress the loosening of the bolt 24. Consequently, as rattling of the mounting member 322 relative to the fixed member 321 is less likely to occur, the playability of the percussion instrument 301 can be improved.

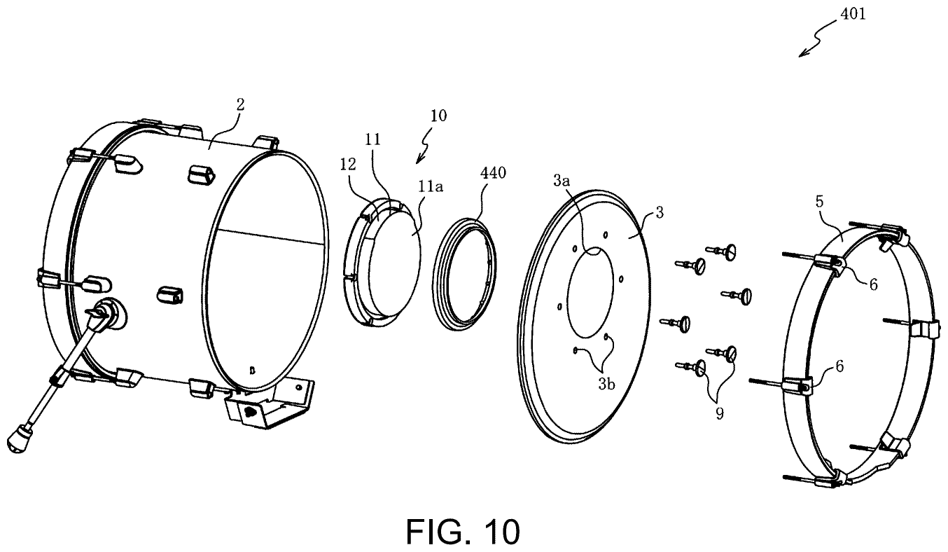

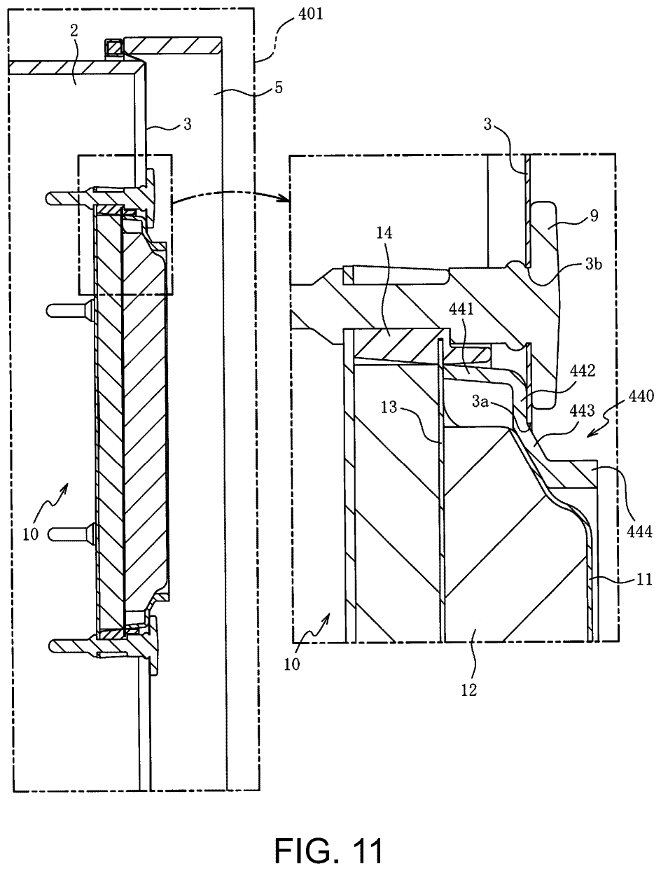

Next, the percussion instrument 401 of the fourth embodiment will be described with reference to FIG. 10 and FIG. 11. The first embodiment described above illustrates a case where the outer edge portion of the membrane member 11 and the cushion 12 (striking surface 11a) of the attachment 10 is compressed by the head 3 and the plate 30. In contrast, the fourth embodiment illustrates a case where the outer edge portion of the membrane member 11 and the cushion 12 (striking surface 11a) is compressed by the head 3 and an annular member 440.

FIG. 10 is an exploded perspective view of the percussion instrument 401 according to the fourth embodiment, and FIG. 11 is a partially enlarged cross-sectional view of the percussion instrument 401. It should be noted that FIG. 11 illustrates a cross-section cut through a plane including the axis of the fastener 9, and the illustration of the mounting fittings 6 (see FIG. 10) is omitted.

As shown in FIG. 10 and FIG. 11, the percussion instrument 401 of the fourth embodiment has the same configuration as the percussion instrument 1 of the first embodiment, except for the point that the annular member 440 is provided instead of the plate 30 (see FIG. 6). Therefore, similar to the first embodiment, the head 3 of the percussion instrument 401 is attached to the shell 2 by the hoop 5 and the mounting fittings 6, and the attachment 10 is attached to the head 3 by the fasteners 9 which are press-fitted into the press-fit holes 3b of the head 3.

In a state where the attachment 10 is attached to the head 3, the annular member 440 is sandwiched between the head 3 and the attachment 10. The inner diameter of the annular member 440 is formed smaller than the diameter of the through hole 3a of the head 3, while the outer diameter of the annular member 440 is formed larger than the diameter of the through hole 3a.

As shown in FIG. 11, the annular member 440 includes an outer circumferential portion 441 that is stacked on the front surface of the support membrane 13 on the outer circumference side of the cushion 12. The outer diameter of the outer circumferential portion 441 (annular member 440) is formed to be the same as (or slightly smaller than) the inner diameter of the frame 14. The outer circumferential portion 441 extends to the front side from the support membrane 13 toward the head 3, and a bent portion 442 is bent from the front end of the outer circumferential portion 441 toward the inner circumference side of the annular member 440. The bent portion 442 is a portion that extends approximately parallel to the head 3, and an inclined portion 443 extends toward the inner circumference side of the annular member 440 from the inner edge of the bent portion 442.

The inclined portion 443 inclines away from the support membrane 13 toward the inner circumference side of the annular member 440, and the portion on the inner edge side of the inclined portion 443 protrudes to the front side of the head 3 through the through hole 3a. A protruding portion 444 protrudes toward the front side from the inner edge of the inclined portion 443, and these portions 441 to 444 constituting the annular member 440 are integrally formed using a resin material.

In the state where the attachment 10 is attached to the head 3, the outer edge portion of the cushion 12 is compressed by the head 3 and the annular member 440. The annular member 440 is formed into an annular shape using a material harder than the head 3 (membrane member 11), making it possible to uniformly regulate the expansion deformation of the outer edge of the cushion 12 over the entire circumference of the cushion 12. Therefore, the durability of the membrane member 11 and the cushion 12 can be improved.

In addition, the inclined portion 443 that inclines away from the support membrane 13 toward the inner circumference side of the annular member 440 is formed on the annular member 440, and this inclined portion 443 presses the outer edge portion of the membrane member 11 and the cushion 12. Thus, it is possible to gradually reduce the compression amount of the cushion 12 compressed by the annular member 440 (inclined portion 443) toward the inner circumference side of the cushion 12 while keeping the compression amount large on the outer edge side of the cushion 12.

Therefore, in the region on the outer edge side of the cushion 12, the expansion deformation of the cushion 12 can be effectively suppressed, while the compression amount of the cushion 12 can be reduced on the inner side. In the region where the compression amount of the cushion 12 is small, it becomes difficult for sagging to occur in the cushion 12, so the durability of the cushion 12 can be improved.

Although the disclosure has been described above based on the foregoing embodiments, the disclosure is not limited to the above embodiments in any way, and it can be easily inferred that various improvements and modifications are possible within the scope that does not deviate from the spirit of the disclosure.

Each of the above embodiments illustrates a case where the percussion instruments 1, 201, 301, and 401 are electronic percussion instruments (electronic drums) each including the sensor 17, but the disclosure is not necessarily limited thereto. For example, the percussion instruments 1, 201, 301, and 401 may be percussion instruments that do not include the sensor 17. Furthermore, although each of the above embodiments illustrates the structures of the lifters 20, 220, and 320 in the percussion instruments 1, 201, 301, and 401 where the attachment 10 is attached to the head 3, such structures of the lifters 20, 220, and 320 can also be applied to an acoustic bass drum.

Each of the above embodiments illustrates a case where the lifters 20, 220, and 320 (fixed members 21, 221, and 321) are fixed to the outer circumferential surface of the shell 2, but the disclosure is not necessarily limited thereto. For example, the lifters 20, 220, and 320 may be fixed to the hoop 5. In other words, the fixing positions of the lifters 20, 220, and 320 relative to the percussion instruments 1, 201, 301, and 401 (housing) can be appropriately changed.

Each of the above embodiments illustrates a case where the shapes of the lifters 20, 220, and 320 are left-right symmetrical, but the disclosure is not necessarily limited thereto. For example, the shapes of the lifters 20, 220, and 320 may be left-right asymmetrical, and the specific shapes of the lifters 20, 220, and 320 are not limited to the above-mentioned forms. In other words, the shapes of the lifters 20, 220, and 320 can be appropriately changed as long as the configuration allows the fastening portions 22b, 222b, and 322b to be provided on both sides in the left-right direction of the mounting portion 22a, and the fastening portions 22b, 222b, and 322b to be fastened at positions where the axial centers of the left and right bolts 24 do not align.

Each of the above embodiments illustrates a case where the portions of the fixed members 21, 221, and 321 or the mounting members 22, 222, and 322 are integrally formed by bending a metal plate. However, a portion of the fixed members 21, 221, and 321 or the mounting members 22, 222, and 322 may be formed separately from other portions.

Each of the above embodiments illustrates a case where the membrane member 11 and the cushion 12 (that is, the hit body forming the striking surface 11a) are disc-shaped, but the disclosure is not necessarily limited thereto. The membrane member 11 and the cushion 12 may be polygonal (for example, rectangular), and in this case, the through hole 3a of the head 3, the support body (support membrane 13, frame 14, cushion 15, mounting plate 16, etc.), and the annular member 440 may be formed into a shape corresponding to the membrane member 11 and the cushion 12.

Each of the above embodiments illustrates a case where the outer edge portion of the cushion 12 is compressed by the head 3 (plate 30 and annular member 440) in a state before the striking surface 11a is hit, but the disclosure is not necessarily limited thereto. For example, the expansion deformation of the outer edge of the cushion 12 can be regulated by the head 3 (plate 30 and annular member 440) as long as the head 3 (plate 30 and annular member 440) is at least in contact with the membrane member 11 in the state before the striking surface 11a is hit.

Each of the above embodiments illustrates a case where the plate 30 or the annular member 440, which is harder than the head 3 (membrane member 11), is provided between the head 3 and the membrane member 11, but the disclosure is not necessarily limited thereto. For example, the plate 30 and the annular member 440 may be omitted, or a configuration using both the plate 30 and the annular member 440 (with the plate 30 interposed between the head 3 and the annular member 440) may be employed. Additionally, the plate 30 may be attached to the front surface of the head 3.

Each of the above embodiments illustrates a configuration in which the attachment 10 is attached to the head 3, that is, a configuration in which the expansion deformation of the outer edge portion of the cushion 12 is regulated by the head 3, but the disclosure is not necessarily limited thereto.

For example, a member corresponding to the annular member 440 (a member having a shape that can press the outer edge of the membrane member 11 and the cushion 12) may be attached to the frame 14, or may be integrally formed with the frame 14. In the case of such a configuration, it is possible to regulate the expansion deformation of the outer edge of the cushion 12 with the member corresponding to the annular member 440 while using the attachment 10 itself detached from the head 3 as a percussion instrument (or using the attachment 10 with the sensor 17 removed as a practice pad).

Each of the above embodiments illustrates a case where multiple (annular fan-shaped) plates 30 are arranged in a ring shape, or a case where the annular member 440 is formed into a ring shape, but the disclosure is not necessarily limited thereto. For example, the multiple plates 30 may be integrally formed into a single ring-shaped plate 30, or the annular member 440 may be divided into multiple pieces in the circumferential direction.

Further, the shape of the multiple plates 30 or the annular member 440 is not limited to a ring shape, and the shape of the plates 30 or the annular member 440 can be appropriately changed as long as the through hole 3a can be surrounded. Therefore, for example, a single annular plate 30 (or divided into multiple pieces) may be formed by cutting out a circular hole in the center of a polygonal (for example, rectangular) resin plate, or rectangular plates 30 may be arranged into an annular shape.

Each of the above embodiments illustrates a case where the cushion 15 is sandwiched between the support membrane 13 and the mounting plate 16, or a case where the sensor 17 is sandwiched between the cushion 15 and the mounting plate 16, but the disclosure is not necessarily limited thereto. For example, the cushion 15 may be omitted, or the sensor 17 may be attached to the rear surface of the mounting plate 16.

Each of the above embodiments illustrates a case where the cushion 12 is formed using a foam material with a higher density than the cushion 15, but the disclosure is not necessarily limited thereto. For example, the cushion 12 and the cushion 15 may have the same density, or the cushion 12 may be formed using a foam material with a lower density than the cushion 15. Each of the above embodiments illustrates a case where the overlap margin La with the

head 3 in the region R including the upper edge of the membrane member 11 is formed larger than the overlap margin Lb with the head 3 in other regions, but the disclosure is not necessarily limited thereto. For example, the overlap margin La in the region R including the upper edge of the membrane member 11 may be smaller than the overlap margin Lb in other regions, or these overlap margins La and Lb may be of the same dimension.

The first embodiment described above illustrates a case where the left and right fastening surfaces of the lifter 20 are each fastened by one bolt 24, but the disclosure is not necessarily limited thereto. For example, the left and right fastening surfaces may each be fastened by multiple bolts 24.

The first embodiment described above illustrates a case where the bent portion 21c and the fastening portion 22b are fastened with the bolt 24 above the vertical center C1 of the left and right fastening surfaces of the lifter 20, but the disclosure is not necessarily limited thereto. For example, the bolt 24 may be provided at the vertical center C1 of the fastening surface or below.

The first embodiment described above illustrates a case where the bent portion 21c (fixed member 21) is fastened to the inner side in the left-right direction of the fastening portion 22b, but the disclosure is not necessarily limited thereto. For example, the fastening portion 22b (mounting member 22) may be fastened to the inner side in the left-right direction of the bent portion 21c. In this case, the long hole 22b1 (see FIG. 2) is formed in the bent portion 21c and the female threaded hole 21c1 (see FIG. 2) is formed in the fastening portion 22b, so that it is possible to fasten the bolt 24 from the lateral side of the bent portion 21c and the fastening portion 22b while allowing adjustment of the fixing position of the mounting member 22 relative to the fixed member 21 in the front-rear direction.

What is claimed is:

1. A percussion instrument, comprising:
a housing, and a lifter provided on an outer circumference side of the housing,
wherein the lifter comprises a fixed member fixed to a housing side, a mounting member configured to have a variable mounting position in a front-rear direction relative to the fixed member, and a bolt fixing the mounting member to the fixed member,
the mounting member comprises a mounting portion to which a foot pedal is attached, and fastening portions provided on both sides of the mounting portion in a left-right direction and fastened to the fixed member by a pair of the bolts on left and right sides, and
a pair of the bolts fasten the fastening portions at positions where respective axial centers do not align.

2. The percussion instrument according to claim 1, wherein each of the fastening portions inclines upward from the mounting portion toward an outer side in the left-right direction.

3. The percussion instrument according to claim 2, wherein the bolt is provided above a vertical center of fastening surfaces between the fixed member and the fastening portions.

4. The percussion instrument according to claim 2, wherein the fixed member is fastened to an inner side in the left-right direction of the fastening portions.

5. The percussion instrument according to claim 2, wherein the mounting portion and the fastening portions are formed by bending a metal plate.

6. The percussion instrument according to claim 2, wherein the fixed member comprises a fixed portion fixed to the housing side, a hanging portion hanging downward from the fixed portion, and bent portions which are bent toward a front side from both left and right end sides of the hanging portion and to which the fastening portions are fastened.

7. The percussion instrument according to claim 6, wherein the fixed portion, the hanging portion, and the bent portions are formed by bending a metal plate.

8. The percussion instrument according to claim 1, wherein the fixed member comprises a hanging portion with left and right ends extended to incline downward toward an outer side in the left-right direction.

9. The percussion instrument according to claim 8, wherein left and right ends of the mounting portion are extended toward the outer side in the left-right direction to serve as fastening portions.

10. The percussion instrument according to claim 1, wherein the fixed member comprises a hanging portion with left and right ends extended toward an outer side in the left-right direction.

11. The percussion instrument according to claim 10, wherein the mounting member includes bent portions bent upward from left and right ends of the mounting portion, and fastening portions bent toward the outer side in the left-right direction respectively from upper ends of the bent portions.

12. A mounting method for a mounting member in a percussion instrument, which comprises a housing, and a lifter provided on an outer circumference side of the housing,
wherein the lifter comprises a fixed member fixed to a housing side, the mounting member configured to have a variable mounting position in a front-rear direction relative to the fixed member, and a bolt fixing the mounting member to the fixed member, and
the mounting member comprises a mounting portion to which a foot pedal is attached, and fastening portions provided on both sides of the mounting portion in a left-right direction and fastened to the fixed member by a pair of the bolts on left and right sides, the mounting method comprising:
attaching the mounting member to the fixed member by fastening the fastening portions with a pair of the bolts whose axial centers do not align.

13. The mounting method for the mounting member according to claim 12, wherein each of the fastening portions inclines upward from the mounting portion toward an outer side in the left-right direction.

14. The mounting method for the mounting member according to claim 13, wherein the bolt is provided above a vertical center of fastening surfaces between the fixed member and the fastening portions.

15. The mounting method for the mounting member according to claim 13, wherein the fixed member is fastened to an inner side in the left-right direction of the fastening portions.

16. The mounting method for the mounting member according to claim 13, wherein the mounting portion and the fastening portions are formed by bending a metal plate.

17. The mounting method for the mounting member according to claim 13, wherein the fixed member comprises a fixed portion fixed to the housing side, a hanging portion hanging downward from the fixed portion, and bent portions which are bent toward a front side from both left and right end sides of the hanging portion and to which the fastening portions are fastened.

18. The mounting method for the mounting member according to claim 17, wherein the fixed portion, the hanging portion, and the bent portions are formed by bending a metal plate.

19. The mounting method for the mounting member according to claim 12, wherein the fixed member comprises a hanging portion with left and right ends extended to incline downward toward an outer side in the left-right direction.

20. The mounting method for the mounting member according to claim 19, wherein left and right ends of the mounting portion are extended toward the outer side in the left-right direction to serve as fastening portions.
